(19) United States
(12) Patent Application Publication
(10) Pub. No.: US 2012/0223892 A1
(43) Pub. Date: Sep. 6, 2012

(54) DISPLAY DEVICE FOR SUSPENDING AUTOMATIC ROTATION AND METHOD TO SUSPEND AUTOMATIC SCREEN ROTATION

(75) Inventors: Masaki Matsubara, Sagamihara-shi (JP); Eiji Ogata, Fujisawa-shi (JP)

(73) Assignee: LENOVO (SINGAPORE) PTE. LTD., Singapore (SG)

(21) Appl. No.: 13/039,899

(22) Filed: Mar. 3, 2011

(51) Int. Cl. G06F 3/041

(52) U.S. Cl. 345/173

(57) ABSTRACT

A display device for displaying information thereon, comprising a display unit adapted to display information in a plurality of display orientations, an orientation determination unit adapted to determine a physical orientation of the display device, a touch sensor adapted to sense a touch input from a user, and a display controller adapted to rotate the information displayed by the display unit from a first display orientation to a second display orientation when the orientation determination unit determines a change in the physical orientation, wherein the display controller suspends rotation of the information displayed by the display unit in the first orientation when the touch sensor senses a touch input substantially contemporaneously with when the orientation determination unit determines the change in the physical orientation.

### BACKGROUND OF THE INVENTION

1. Technical Field

The present inventions relate to a display device that provides a plurality of display orientations and methods for controlling a display device to switch between a plurality of display orientations.

2. Description of Related Art

Conventional display devices use accelerometers to align the orientation of the information displayed on a display screen to the physical orientations in which the display devices are held. For example, a typical consumer electronic device such as a tablet PC, a smart phone, or a digital camera includes a rectangular display screen. As shown in FIG. 1A, the physical orientation of the display device may be rotated from a first physical orientation in which a horizontal dimension of the device is longer than a vertical dimension of the device to a second physical orientation in which the horizontal dimension is shorter than the vertical dimension of the device. The relationship between the vertical and horizontal dimensions of a display screen is commonly referred as an aspect ratio of the display screen.

Furthermore, a typical display device performs an automated rotation of the information displayed on the display screen in response to a user's physical rotation of the display device. An implicit assumption is made that the user intended to view the information in the same display orientation as that of the display screen. As a consequence, the display orientation of the information displayed by the display device is maintained in the same upright orientation. As shown in FIG. 1B, the rotation of the physical orientation of the display device is evidenced by a change from a longer vertical dimension (shown on the left of FIG. 1B) to a longer horizontal dimension (shown on the right in FIG. 1B). The result of this automated rotation of the information displayed is evidenced by the fact that the information shown in both physical orientation remained in the same display orientation.

However, a side effect of this automated rotation is that a user cannot easily take advantage of the alternative aspect ratio of the display device to display information in a different display orientation. As shown in FIG. 1B, a spreadsheet document is digitized and shown in a vertical writing orientation where each column of the tabular data contained in the spreadsheet document extends from the left of the display screen to the right of the display screen (i.e., the horizontal direction, such that the writing in each column extends in the vertical direction). The aspect ratio of the display device is such that the longer, vertical dimension of the display device appropriately displays the entire columnar span of the tabular data. Since the document is shown in a vertical orientation, it would be more advantageous to physically rotate the display device while maintaining the display orientation of the spreadsheet document relative to the display device. Here, if the display device performs an automated rotation of the display orientation (shown on the right in FIG. 3B), the spreadsheet document is rotated in a direction to counter the rotation of the display device, the display screen no longer displays all columns of the tabular data because the columnar span of the tabular data now coincides with a shorter vertical dimension of the display device.

Other conventional display devices may provide an display aspect ratio of equal vertical and horizontal dimensions, for example, Apple's iPod Nano. Such device similarly provides automated rotation of the display orientation based on the same assumption that the user intended to maintain the display orientation despite a physical rotation of the display device.

These conventional display devices provide no intuitive or fast method for enabling and disabling the automated rotation of the display orientation. For example, some display devices provide a physical button for disabling the automated switch of display orientation. Other display devices provide a sequence of software configuration step to disable the same. Other display devices, such as the iPod Nano, provide an alternative method to manual change the display orientation after an automated orientation by requiring the user to perform a sequence of “gesture” touch actions on a touch-sensitive screen.

### SUMMARY OF THE INVENTION

There is provided a display device for displaying information thereon, comprising a display unit adapted to display information in a plurality of display orientations, an orientation determination unit adapted to determine a physical orientation of the display device, a touch sensor adapted to sense a touch input from a user, and a display controller adapted to rotate the information displayed by the display unit from a first display orientation to a second display orientation when the orientation determination unit determines a change in the physical orientation, wherein the display controller suspends rotation of the information displayed by the display unit in the first orientation when the touch sensor senses a touch input substantially contemporaneously with when the orientation determination unit determines the change in the physical orientation.

### BRIEF DESCRIPTION OF THE DRAWINGS

FIG. 1 depicts a display device that performs an automated rotation according to a conventional method;

FIG. 2A depicts a display device according to an embodiment of the present invention;

FIG. 2B depicts an orientation determination unit according to an embodiment of the present invention;

FIG. 3 depicts a display device according to a first embodiment of the present invention;

FIG. 4 depicts a method of controlling the display device according to the first embodiment of the present invention;

FIG. 5 depicts a display device according to a second embodiment of the present invention;

FIG. 6 depicts a method of controlling the display device according to the second embodiment of the present invention;

FIG. 7A depicts a method of controlling the display device according to a third embodiment of the present invention;

FIG. 7B depicts a method of controlling the display device according to a fourth embodiment of the present invention;

FIG. 8 depicts a display device according to a fifth embodiment of the present invention.

### DETAILED DESCRIPTION OF A PREFERRED EMBODIMENT

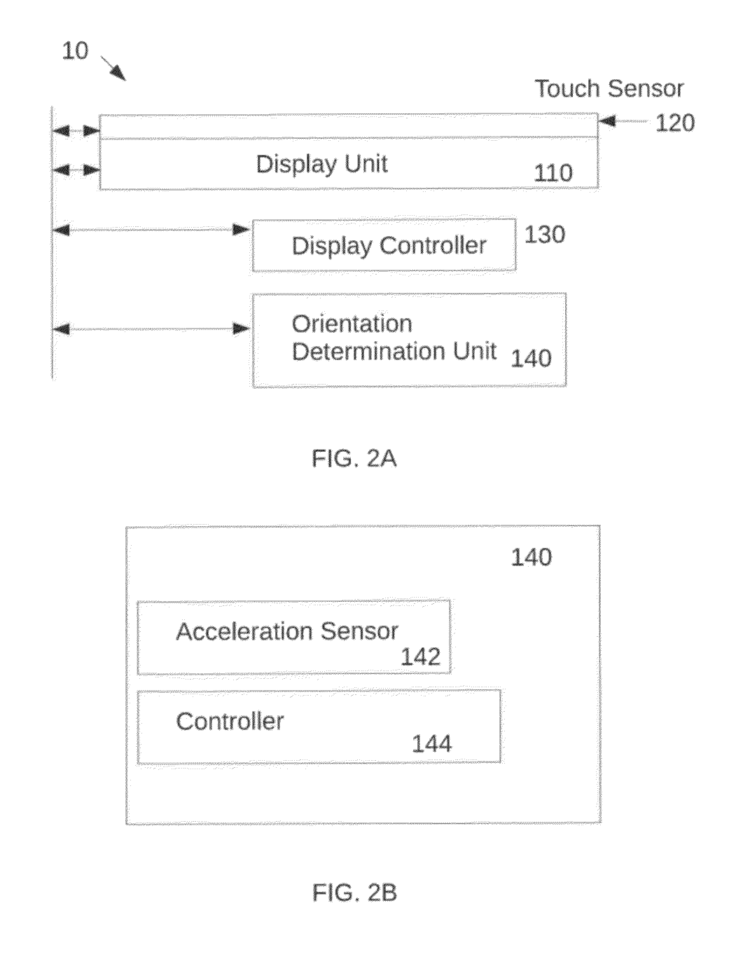

FIG. 2A depicts a display device 10 according to an embodiment of the present invention. The display device includes a display unit 110, a touch sensor 120, a display controller 130, and an orientation determination unit 140. The display unit 110 may be constructed with a LCD display screen, an organic LED display screen or any other convention display screen. The display unit 110 is adapted to display information in a plurality of display orientations under the control of the display controller 130. Accordingly, the display controller 130 is adapted to rotate the information displayed on the display unit 110 from a first display orientation to a second display orientation when an orientation determination unit 140 determines a change in the physical orientation of the display device 10. For example, the orientation determination unit can be an accelerometer or a micromechanical gyro. Furthermore, a touch sensor 120 is provided to substantially overlap a portion of a surface of the display unit 110, and to sense a touch input from a user. In an embodiment of the present invention, the touch sensor 120 substantially overlaps an entire surface of the display unit 110.

According to a preferred embodiment of the present invention, the display controller 130 suspends the rotation of the information displayed by the display unit 110, from a first orientation to a second orientation, when the touch sensor 120 senses a touch input from the user substantially contemporaneously with when the orientation determination unit 140 determines the change in the physical orientation of the display device 10. For example, the display controller can be a video processor or a general purpose processor executing a display driver software.

FIG. 2B depicts a preferred embodiment of the orientation determination unit 140. As shown, the orientation determination unit 140 includes an acceleration sensor 142 and a controller 144. The acceleration sensor measures an acceleration of the display device 10 effected by an user or other external forces, and outputs an analog voltage associated with this acceleration to the A/D input terminals in the controller 144. The controller 144 A/D-converts the voltage input from the acceleration sensor 142 to obtain an acceleration value. The obtained acceleration value is stored and used to determine whether the display device 10 has tilted or rotated by a predetermined amount so as to require an automated rotation. If so determined, the rotation of display device is communicated to the display controller 130 in order to allow the display controller to determine whether an automated rotation of the display orientation is appropriate.

If the display controller 130 determines that the display device 10 has undergone a predetermined amount of physical rotation, then the display controller 130 performs an automated rotation of the information displayed on the display unit 110 from a first display orientation to a second orientation, so as to maintain the displayed information in an upright display orientation (parallel with an axis determined by a direction of the Earth's gravitational force). Any conventional methods for determining the predetermined amount of physical rotation may be used, for example, as taught by U.S. Patent Application, 2008/129666A1.

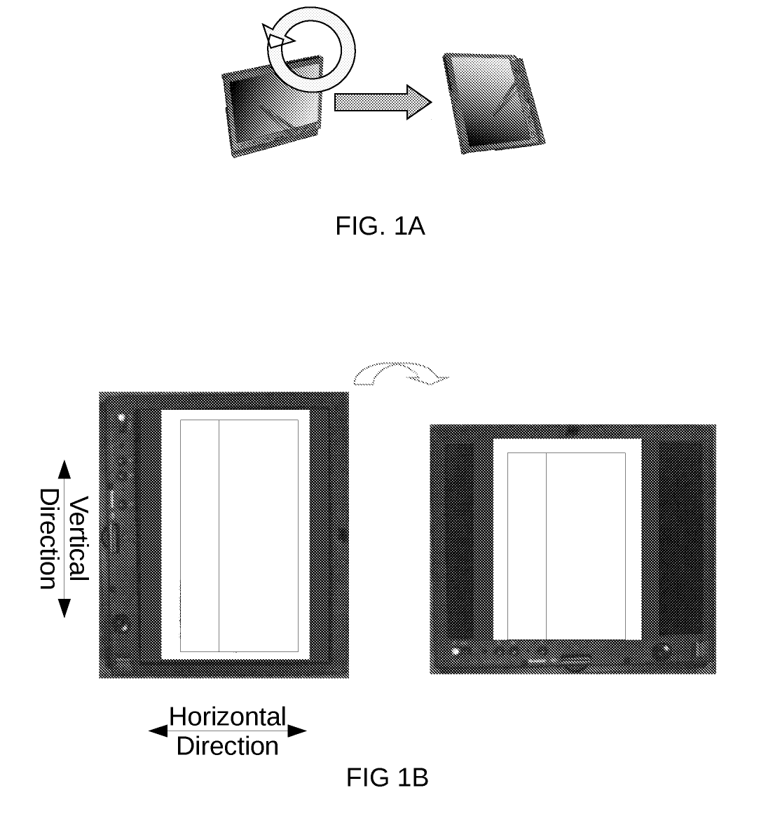

As discussed above, this automated rotation of the display orientation may be inconvenient for a user. For example, if a user is reclined in a substantially horizontal reading position, or if a user is holding the display device in an physical orientation where the planar surface of the display unit is orthogonal to the axis of the Earth's gravitational force, or if the direction of a scanned document disagrees with a proper display orientation, the “upright” orientation maintained by the automated rotation no longer corresponds to the user's desired viewing orientation. In another example, the user may wish to rotate the display device 10 to provide a more advantageous viewing orientation in order to view a document that was inadvertently digitized in a rotated orientation, as previously shown in FIG. 1B.

In these situations, the present invention provides an intuitive and fast method for the user to suspend the automated rotation, which is otherwise performed by the display controller 130, so that the user can view the image on the display device in the most desirable configuration.

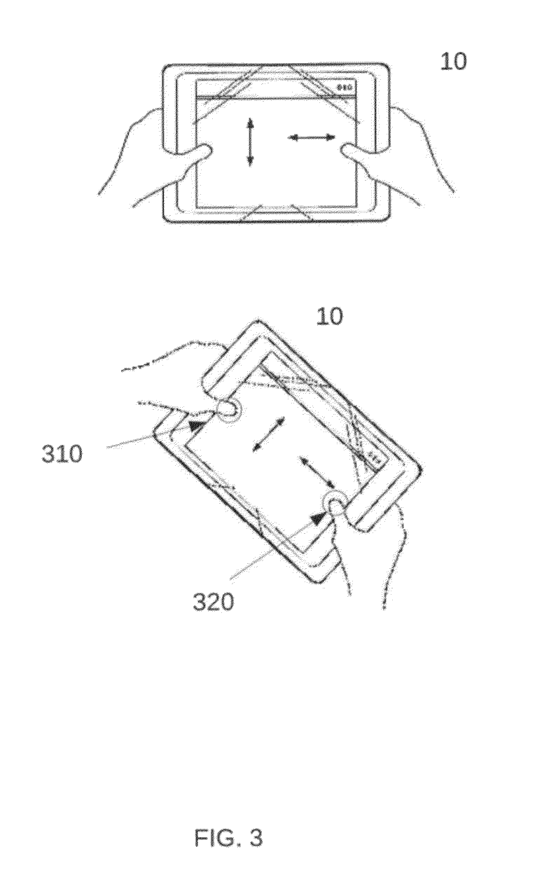

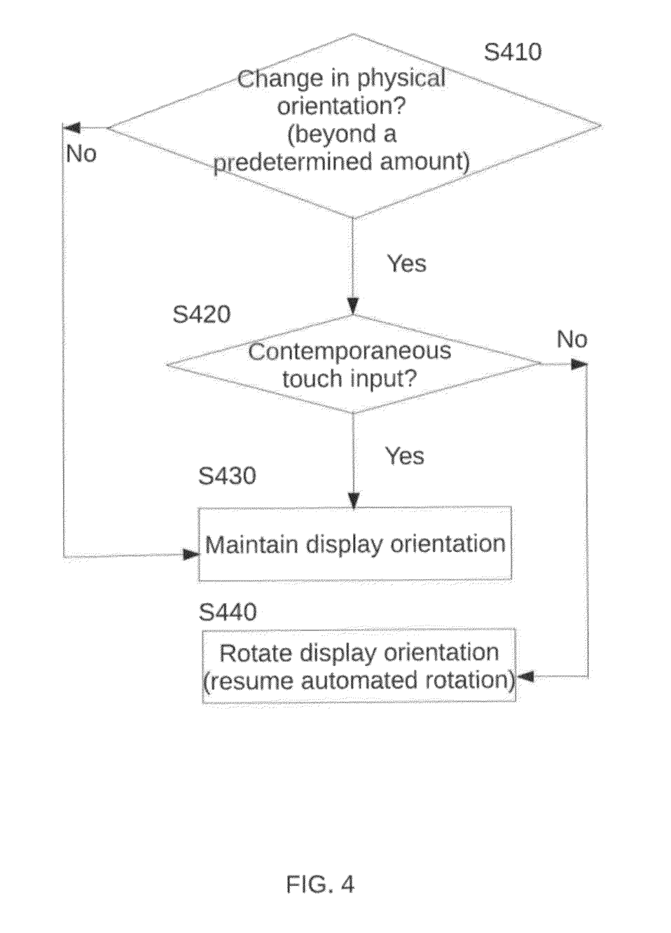

As shown in FIGS. 3 and 4, according to a first embodiment of the present invention, the display controller 130 suspends the rotation of the information displayed by the display unit 110, from a first orientation to a second orientation, when the touch sensor 120 senses a touch input substantially contemporaneously with when the orientation determination unit 140 determines the change in the physical orientation of the display device 10. The touch input is sensed when one or more fingers are held on the screen for a predetermined minimum amount of time.

In particular, as shown in FIGS. 3 and 4, the user holds the display device 10 with a left hand and a right hand, each of which grasps a vertical side of the display device, and rotates the display device in a clockwise direction. As the physical rotation exceeds a predetermined amount, it is determined at step S410, “Yes,” that the display device has undergone a change in its physical orientation. This predetermined amount can be approximately over 45 degrees.

As the user rotates the display device 10, the user's left thumb touches a portion of the touch sensor so as to effect a touch input 310. Therefore, at step S420, it is determined, “Yes,” a contemporaneous touch input has been effected by the user. It should be appreciated that the determination at step S420 maybe logically implemented within a predetermined period of time before or after the determination at S410. This predetermined period can be approximately less than one second. Alternatively, at the step S420, it may be determined “Yes” if either touch input 310 or touch input 320 is effected by the user. A touch input 310 or a touch input 320 that is made substantially contemporaneous with the rotation of the display device 10 is assumed to be a user input to suspend the automated rotation of the display orientation of the information displayed on the display device 10. For example, a time window of approximately one second may be used to determine that both a user touch input and a rotation of the display device occurred substantially contemporaneous with each other. As a result, the display controller 130 suspends the automated rotation at step S430 so as to maintain the display orientation.

In the alternative, if it is determined that a touch input 310 was not substantially contemporaneous with the rotation of the display device 10, the display controller 130 continues to perform an automated rotation of the display orientation at step S440.

Thus, the above first embodiment provides an intuitive and fast method for a user to suspend the automated rotation of the display orientation of the information displayed on the display device.

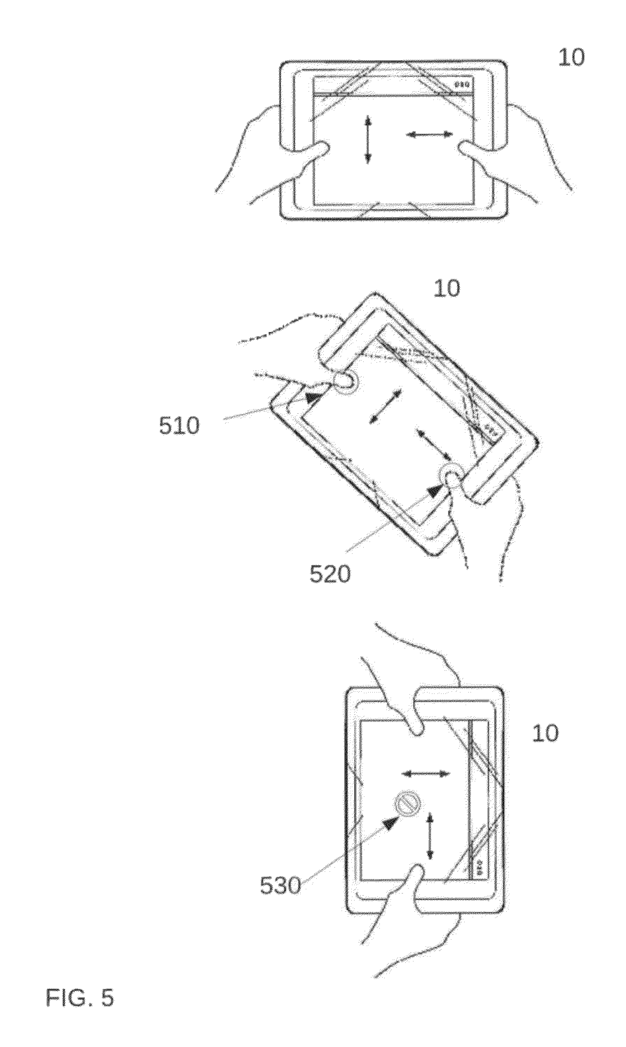

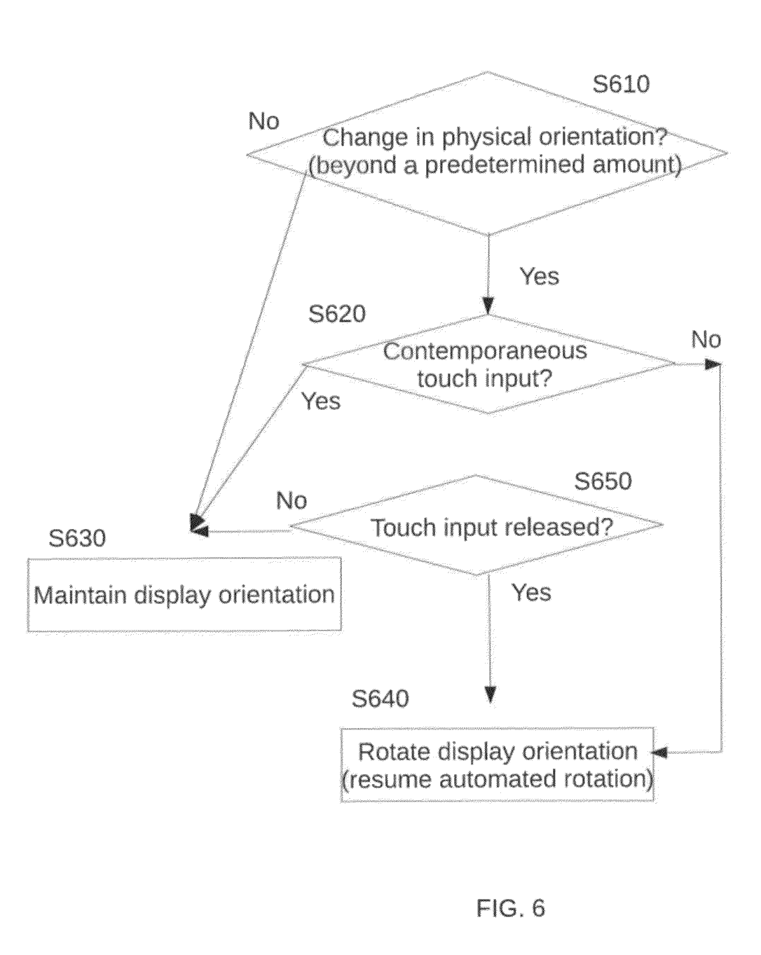

According to a second embodiment, a user is further provided with a method to resume a suspended automated rotation. As shown in FIGS. 5 and 6, the display controller 130 performs steps S610, S620, S630, and S640 in a similar fashion as the steps S410, S420, S430, and S440 in FIG. 4, as discussed above. In addition, the controller 130 performs step S650 and determines whether the contemporaneous touch input determined at step S620 is released or no longer effected by the user. In the case that touch input 510 was determined to be substantially contemporaneous with the rotation of the display device 10, the controller 130 determines whether touch input 510 continues to be effected by the user. Alternatively, if either touch input 510 or touch input 520 was determined to be substantially contemporaneous with the rotation of the display device 10, the controller determines whether both touch input 510 and touch input 520 has been released or either of the two touch inputs continues to be effected by the user. If the contemporaneous touch input is determined to be released at step S650, the controller 130 resumes the automated rotation at step S640. If instead the contemporaneous touch input is determined not to have been released, or “No,” the displayer controller 130 performs step S630 in which the automated rotation continues to be suspended.

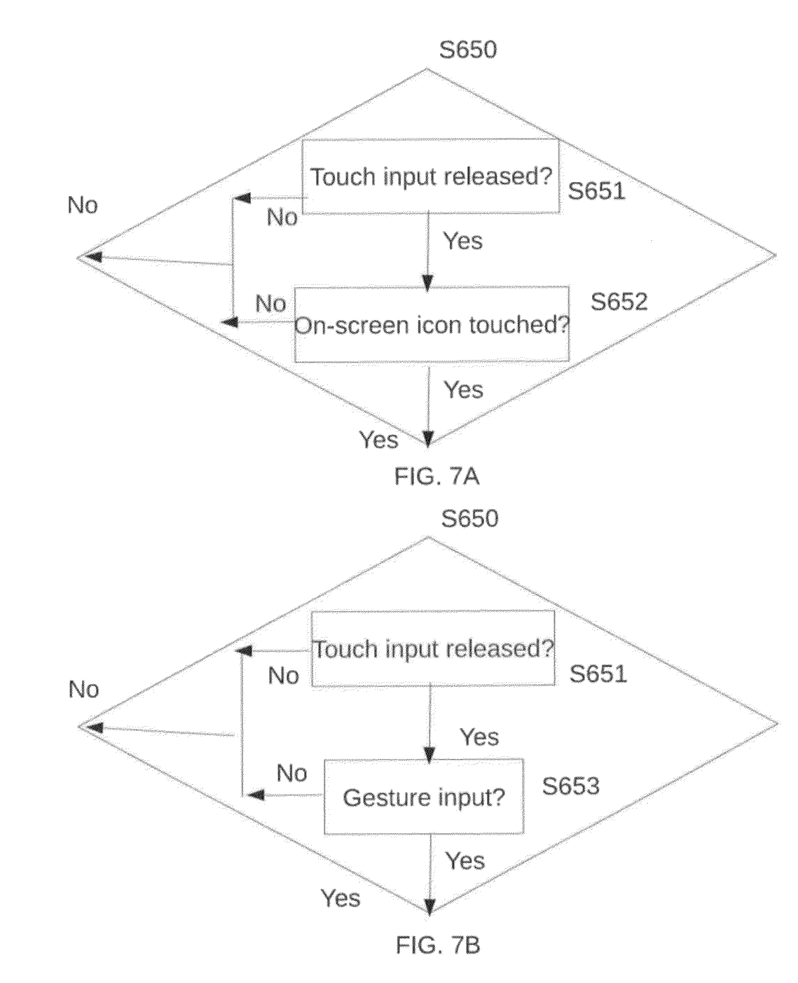

According to a third embodiment, shown in FIG. 7A, the step S650 includes a step S651 that determines whether the contemporaneous touch input has been released, and further include a step S652 that determines whether the user has effected a touch input on an on-screen icon 530 (FIG. 5) provided after the display controller has suspended the automated rotation. If it is determined that the user has both released the contemporaneous touch input and effected the touch input on the on-screen icon 530, the display controller 130 resumes the automated rotation. Other icons composed of words, symbols, or any combination thereof may be displayed as the on-screen icon 530.

According to a fourth embodiment, shown in FIG. 7B, the step S650 includes a step S651 that determines whether the contemporaneous touch input has been released, and further include a step S652 that determines whether the user has effected a gesture touch input, for example, a five-fingered twist gesture. Other gestures may be used as the gesture touch input. For example, a semicircular swipe gesture, or two-finger twist gesture. If it is determined that the user has both released the contemporaneous touch input and effected the gesture touch input, the display controller 130 resumes the automated rotation.

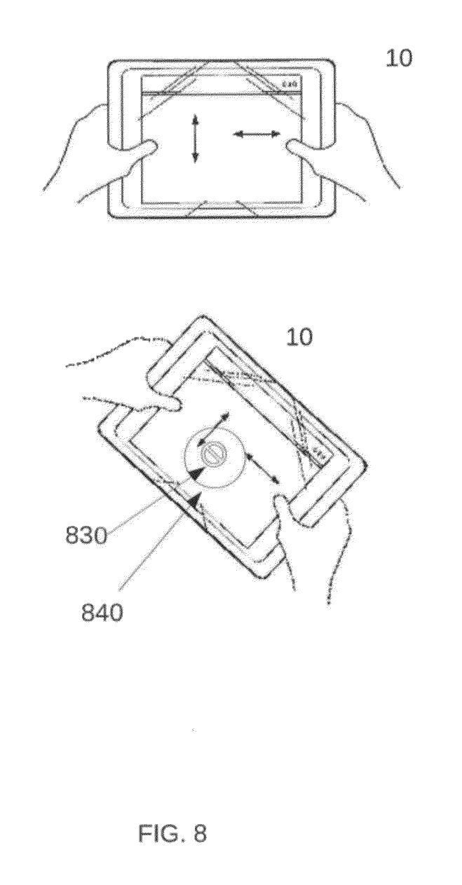

According to a fifth embodiment, shown in FIG. 8, as the user rotates the display device 10, an on-screen icon 830 is displayed on the display screen and the automated rotation of the display information is suspended. The on-screen icon 830 is displayed for a predetermined period of time so as to prompt the user that the automated rotation is suspended. If the user instead preferred the automated rotation to be effected, the user may effect a touch input 840 substantially over the displayed on-screen icon 830 to resume the automated rotation of the display information.

What is claimed is:

1. A display device for displaying information thereon, comprising:
a display unit adapted to display information in a plurality of display orientations;
an orientation determination unit adapted to determine a physical orientation of the display device;
a touch sensor adapted to sense a touch input from a user; and
a display controller adapted to effect a rotation of the information displayed by the display unit from a first display orientation to a second display orientation when the orientation determination unit determines a change in the physical orientation, wherein
the display controller suspends the rotation of the information displayed by the display unit in the first orientation when the touch sensor senses a touch input substantially contemporaneously with when the orientation determination unit determines the change in the physical orientation.

2. The display device of claim 1, wherein
the display controller resumes the rotation when the touch sensor no longer senses the touch input.

3. The display device of claim 2, wherein
the display controller resumes the rotation when the touch sensor no longer senses the touch input and further senses a gesture input.

4. The display device of claim 1, wherein
the touch sensor senses a first touch input and a second touch input from the user; and
the display controller suspends the rotation when at least one of the first touch input and the second touch input remain sensed by the touch sensor substantially contemporaneously with the change in the orientation of the display device determined by the orientation determination module.

5. The display device of claim 4, wherein
the display controller resumes the rotation when the touch sensor no longer senses the first touch input and the second touch input.

6. The display device of claim 5, wherein
the display controller resumes the rotation when the touch sensor no longer senses the first touch input and the second touch input and further senses a gesture input.

7. The display device of claim 1, wherein
the display controller further displays an icon for resuming the rotation; and
the display controller resumes the rotation when the touch sensor no longer senses the touch input and further senses a touch input substantially collocated with the icon.

8. The display device of claim 4, wherein
the display controller further displays an icon for resuming the rotation; and
the display controller resumes the rotation when the touch sensor no longer senses the touch input and further senses a touch input substantially collocated with the icon.

9. The display device of claim 6, wherein
the gesture input is a five finger rotation gesture input.

10. A method of controlling a display device for displaying information in a plurality of display orientations thereon, comprising:
determining a physical orientation of the display device;
sensing a touch input from a user; and
rotating the information displayed from a first display orientation to a second display orientation when the determining step determines a change in the physical orientation, wherein
the rotating step suspends the rotating of the information displayed in the first orientation when the sensing step senses a touch input substantially contemporaneously with when the determining step determines the change in the physical orientation.

11. The method of controlling a display device of claim 10, wherein
the rotating step resumes the rotating when the sensing step no longer senses the touch input.

12. The method of controlling a display device of claim 11, wherein
the rotating step resumes the rotating when the sensing step no longer senses the touch input and further senses a gesture input.

13. The method of controlling a display device of claim 10, wherein
the sensing step senses a first touch input and a second touch input from the user; and
the rotating step suspends the rotating when at least one of the first touch input and the second touch input remain sensed by sensing step substantially contemporaneously with the change in the physical orientation of the display device determined by the determining step.

14. The method of controlling a display device of claim 13, wherein
the rotating step resumes the rotating when the sensing step no longer senses the first touch input and the second touch input.

15. The method of controlling a display device of claim 5, wherein
rotating step resumes rotation when the sensing step no longer senses the first touch input and the second touch input and further senses a gesture input.

16. The method of controlling a display device of claim 10, further comprising
displaying an icon for resuming rotation; wherein
the rotating step resumes rotation when the sensing step no longer senses the touch input and further senses a touch input substantially collocated with the icon.

17. The method of controlling a display device of claim 13, further comprising:
displaying an icon for resuming the rotation; and
the rotating step resumes rotation when the touch sensor no longer senses the touch input and further senses a touch input substantially collocated with the icon.

18. The method of controlling a display device of claim 15, wherein
the gesture input is a five finger rotation gesture input.

19. A display device for displaying information thereon, comprising:
a display unit adapted to display information in a plurality of display orientations;
an orientation determination unit adapted to determine a physical orientation of the display device;
a touch sensor adapted to sense a touch input from a user; and
a display controller adapted to effect a rotation of the information displayed by the display unit from a first display orientation to a second display orientation when the orientation determination unit determines a change in the physical orientation, wherein
the display controller further displays an icon for reversing the rotation; and
the display controller reverses the rotation when the touch sensor senses a touch input substantially collocated with the icon.

20. A method of controlling a display device for displaying information in a plurality of display orientations thereon, comprising:
determining a physical orientation of the display device;
sensing a touch input from a user; and
rotating the information displayed from a first display orientation to a second display orientation when the determining step determines a change in the physical orientation;
displaying an icon for reversing the rotation; and
reversing the rotation when the sensing step senses a touch input substantially collocated with the icon.

21. A display device for displaying information thereon, comprising:
a display that displays information in a plurality of display orientations;
an accelerometer that determines a physical orientation of the display device;
a touch sensor that senses a touch input from a user; and
a display controller that effects a rotation of the information displayed by the display from a first display orientation to a second display orientation when the accelerometer determines a change in the physical orientation, wherein
the display controller suspends the rotation of the information displayed by the display in the first orientation when the touch sensor senses a touch input substantially contemporaneously with when the accelerometer determines the change in the physical orientation.
